(19) United States
(12) Patent Application Publication
(10) Pub. No.: US 2026/0222527 A1
(43) Pub. Date: Jul. 30, 2026

(54) ADAPTIVE DEPTH OF FIELD FOR THREE DIMENSIONAL DISPLAYS

(71) Applicant: Dell Products L.P., Round Rock, TX (US)

(72) Inventors: Shohrab Sheikh, Singapore (SG); Wei-Hsiang Chi, Taipei City (TW); Jace W. Files, Round Rock, TX (US)

(73) Assignee: Dell Products L.P., Round Rock, TX (US)

(21) Appl. No.: 19/037,805

(22) Filed: Jan. 27, 2025

(51) Int. Cl. H04N 13/128; H04N 13/302; H04N 13/366

(52) U.S. Cl. CPC H04N 13/128; H04N 13/302; H04N 13/366

(57) ABSTRACT

An information handling system presents content as visual images at an autostereoscopic three-dimensional display having adjustable depth of field by capturing visual images of an end user viewing the three dimensional content and analyzing the visual images of the end user to detect the impact of the three dimensional visual images on the end user. When the end user shows signs of stress from viewing the three dimensional visual images, the depth of field is decreased. When the end user indicates a positive impact by the three dimensional visual images, the depth of field is increased.

### BACKGROUND OF THE INVENTION

### Field of the Invention

The present invention relates in general to the field of information handling system displays, and more particularly to an information handling system adaptive depth of field for three dimensional displays.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems process information with a processor that executes instructions in cooperation with a memory that stores the instructions and information. Stationary information handling systems, such as desktop, tower and server configurations, integrate processing components in a housing that operates at a fixed location with external resources, such as a power outlet and peripheral input devices. For instance, a typical stationary information handling system interfaces with a peripheral display to present information as visual images, a peripheral keyboard to accept key inputs and a peripheral mouse to accept cursor movement inputs. Portable information handling systems integrate the processor, memory, display, keyboard and a battery power source in a portable housing to support mobile operations. Portable information handling systems allow end users to carry a system between meetings, during travel, and between home and office locations so that an end user has access to processing capabilities while mobile. In addition to these integrated input/output devices, portable information handling systems will also typically interact with peripheral devices, such as a peripheral display.

Peripheral displays come in a large variety of sizes that typically present visual images with an array of pixels in a two-dimensional plane. The pixels define visual images with an array of pixel values that are scanned to the display by a timing controller. Generally, display operations are managed by a scalar that includes a processing resource and non-transitory memory with instructions that scale video stream inputs to a resolution of pixel arrays supported by a display panel. In some instances, a display may include an integrated or peripheral camera that captures an image of an end user viewing the display, such as to support a videoconference. Visual image quality is a function of display resolution and viewing area with modern displays including 8K pixels for ultra high definition resolution.

Although display panels typically present visual images in two dimensions, some display panels will support three dimension (3D) visual image presentation. For example, when video content supports three dimensional visual images and end user might activate the three dimensional images by wearing 3D glasses. One recent development supports 3D display presentations with autostereoscopic technology. Autostereoscopic 3D displays create an illusion depth in a two dimensional display without the use of 3D glasses. A lenticular lens array film is added to the display to simulate the effect of a parallax barrier. Two different pixel areas have different images observed by the right and left eye to make a recognizable 3D image. In a stereo 3D display, if the depth of field is small enough then human eyes can adjust the vergence distance different from the focal distance to reduce the disparity. In autostereoscopic 3D displays, the focal distance remains constant to the display screen while the vergence distance is varied to perceive depth. As the depth field increases with an autostereoscopic display, human eyes tend to feel the symptoms of discomfort like eyestrain, dizziness, nausea and headaches. Although a higher depth of field view creates a more immersive experience, it also can increase side effects on an end user, especially over long periods of time or when the end user is a beginner not used to viewing autostereoscopic display images.

### SUMMARY OF THE INVENTION

Therefore, a need has arisen for a system and method which balances an immersive end user experience at an autostereoscopic display with user comfort.

In accordance with the present invention, a system and method are provided which substantially reduce the disadvantages and problems associated with previous methods and systems for presenting three dimensional autostereoscopic visual images at a display. An end user watching three dimensional visual images at the display is observed with a camera to detect the end user’s reaction to the three dimensional visual images and the depth of field for the three dimensional visual images is adjusted based on the end user’s reaction.

More specifically, an information handling system processes information by executing instructions with a processor in cooperation with a memory that stores the instructions and information to present three dimensional visual images at an autostereoscopic display having an adjustable depth of field. A camera observes an end user when watching the three dimensional visual images to determine an end user reaction to the depth of field at which the visual images are presented. When the end user has a negative reaction to the depth of field, such as might be indicated by stress and fatigue, the visual images are presented with a decreased depth of field to improve the end user’s viewing experience by reducing stress caused by viewing the three dimensional visual images. When the end user has a positive reaction to the depth of field, such as might be indicated by happiness and a steady gaze, the visual images are presented with an increased depth of field to improve the end user’s viewing experience by increasing the three dimensional immersive experience. The depth of field is scaled from a maximum depth of field defined by the visual information content to an initial value based on the end user’s initial profile, such as a beginner versus an experienced viewer of three dimensional visual images. In one embodiment, the content presented at the display is analyzed to determine its emotional impact on the end user and then the depth of field is adjusted based on a comparison of the end user’s emotional state versus and emotional state expected from the content.

The present invention provides a number of important technical advantages. One example of an important technical advantage is that an end user’s reaction to presentation of three dimensional visual images is analyzed and applied to optimize a depth of field selection for the presentation of the three dimensional images to the end user. As a result, the end user has as full of an immersive three dimensional experience as possible without experiencing excessive discomfort. Over time, the end user’s capacity to view different depths of fields is tracked and adjusted so that an initial setting for the depth of field scales the visual images based on a maximum depth of field defined by the content. The analysis considers the end user reaction compared with an expected reaction to the visual content. The selected depth of field is applied to determine an optimal end user experience over the time of the visual content, such as to the end of a movie, so that the end user finishes the content with a maximum experience and an acceptable fatigue from watching the visual images.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system interfaced with an autostereoscopic three dimensional display to present three dimensional visual images with a depth of field selected based upon end user reactions to view the three dimensional visual images; and

FIG. 2 depicts a flow diagram of a process for adapting an autostereoscopic three dimensional display to present visual images with an adjustable depth of field based on an end user reaction to three dimensional visual images as captured by a camera.

### DETAILED DESCRIPTION

An information handling system presents three dimensional images at an autostereoscopic display by adjusting depth of field for the presentation of the visual images based on end user reactions to the visual images. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

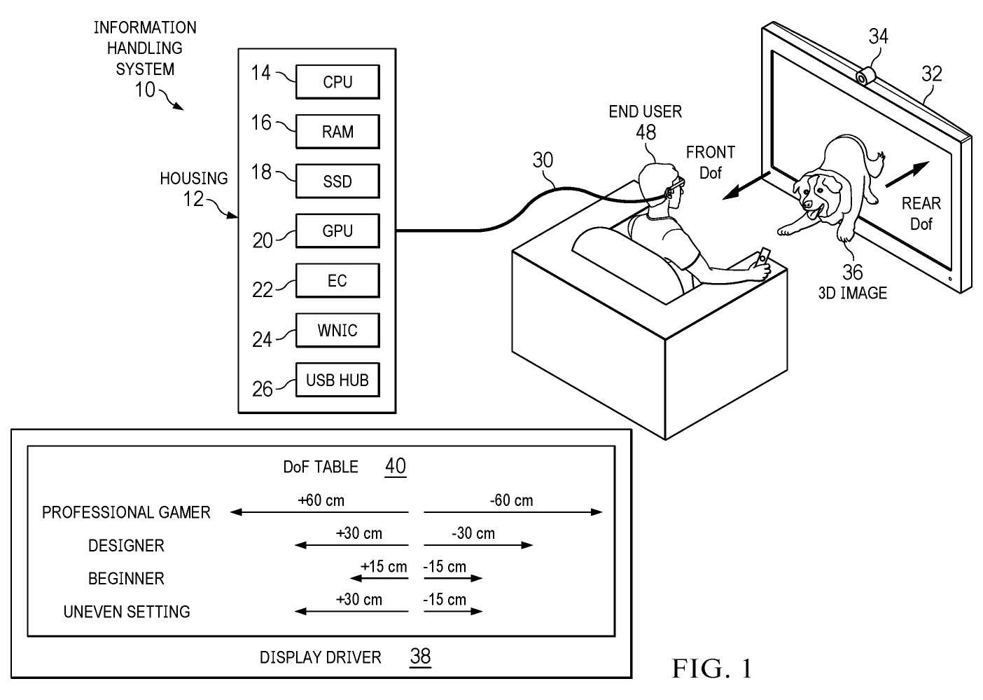

Referring now to FIG. 1, a block diagram depicts an information handling system 10 interfaced with an autostereoscopic three dimensional display 32 to present three dimensional visual images 36 with a depth of field selected based upon end user reactions to view the three dimensional visual images. In the example embodiment, information handling system 10 has a stationary configuration in a housing 12, such as a tower or desktop configuration. In various embodiments information handling system may include a portable configuration with display 32 integrated in the housing or a cloud configuration with display 32 interface through a network to a content provider that serves visual image content from a server information handling system. Alternatively information handling system 10 may include “smart” televisions that integrate a processor and memory for presenting visual images store locally or remotely. The smart television functions may be performed by an external box, such as a cable box or streaming box. The logic described below to manage depth of field for visual image presentation may be performed in a distributed manner across multiple different processors.

In the example embodiment, a central processing unit (CPU) 14 executes instructions to process information in cooperation with a random access memory (RAM) 16 that stores the instructions and information. A solid state drive (SSD) 18 provides non-transient memory, such as flash integrated circuits, that stores the instructions and information during power down of the system. For instance, SSD 18 stores an operating system that coordinates operation of processing components and applications that perform desired functions, such as presenting movie content stored in the SSD. A graphics processing unit (GPU) 20 further processes the information to present the visual images, such as by defining pixel values that are scanned to an array of pixels of display 32. An embedded controller (EC) 22 manages operational conditions in the system, such as application of power, maintenance of thermal constraints and interactions with peripheral devices. A wireless network interface controller (WNIC) 24 supports communications with external devices through wireless signal communication, such as WIFI and BLUETOOTH. A USB hub 26 supports communication with external devices through a USB cable, such as communication of visual images through a display cable 30 to display 32.

In the example embodiment, display 32 is an autostereoscopic display that presents three dimensional images 36 with a depth of field that includes a front depth of field and a rear depth of field. The front depth of field is the distance that the visual image appears to extend forward from the display front panel and the rear depth of field is the distance that the visual image appears to extend rearward and into the display front panel. An end user 48 viewing display 32 is provided with the illusion of depth by adjusting the manner in which the pixels present the visual image to left and right eyes as is described above. In the example embodiment, a display driver 38 runs as part of the operating system to adjust the depth of field at which visual images are presented at display 32. Display driver 38 may operate at one or more of CPU 14, GPU 20 and various other processing resources, such as a scalar. In the example embodiment, display driver 38 has a DOF table 40 that stores four initial settings to present visual images: a professional level with +/- 60cm depth of field; a designer level with +/-30cm depth of field; a beginner level with +/- 15cm depth of field; and an uneven setting with +30cm / -15cm depth of field. A camera 34 captures visual images of end users 48 for analysis to determine the end user reaction to the depth of field of visual images 36. Based on the end user reactions, the depth of field is adjusted with increases in the depth of field enhancing the end user immersive experience and decreases in depth of field reducing end user fatigue from viewing the three dimensional images.

In operation, camera vision is used to detect insights into the end user emotional state to determine adjustments to the depth of field for visual images presented at the display. A variety of techniques are available to gain insights into an end user’s reaction to viewing display three dimensional images. In the example embodiment, these include end user facial indications of fatigue, SAD emotions (stress, anxiety, depression), steady focus and positive emotion (happiness, joyfulness). The techniques for detecting these indications include artificial intelligence, machine learning and facial identification techniques. Examples of these techniques include fatigue detection used in automotive monitoring of drivers, emotion detection for healthcare and marketing, and similar logic. Logic to recognize insights from analysis of an end user face may execute on a CPU, scalar, or camera processing resource. Based upon these insights, the logic determines whether the end user may want the depth of field to increase, decrease or remain unchanged. Generally, indications of stress, such as fatigue and SAD emotions, suggest a decrease of depth of field to reduce the stress felt by the end user; and indications of joy or interest, such as steady focus and positive emotion, suggest an increase in the depth of field to increase the immersive experience of the end user.

Depth of field adjustment is performed by software management to adjust pixel output. The 3D video content includes depth information, such as maximum desired display depth of field. The control logic adjusts depth parameters based on the maximum desired display depth of field with a transfer function at the beginning of the 3D processing pipeline to scale the depth parameters of the 3D video content so as to enable the desired depth of field limit at the 3D display. The scaling is performed from an initial setting for the end user, such as a beginner versus expert as defined in the depth of field table. In performing this scaling, front depth of field and rear depth of field may be scaled independently. Once an end user builds a history of tolerance for viewing the 3D display, the initial setting may be set based on the end user’s history of use. For example, an end user starts with a beginner profile to have a maximum of 15cm depth of field and have that initial setting personalized by the camera monitoring as the model recognizes the end user and learns to adjust depth of field based on camera vision of the end user, such as with a machine learning model. After initialization, the method continuously monitors the camera vision of the end user to determine any reactive action needed to adjust the end user’s comfort or immersive experience. For example, a machine learning model learns from user insights after prior depth of field adjustments to determine the future recommendation. The pace of any adjustment can be learned and improved by the model to ensure smooth transition for different users and changes. Finally, these adjustment actions are feedback to the end user profile so that the next presentation of 3D visual images starts with an appropriate initial setting.

In one example embodiment, camera vision evaluation of the impact of viewing 3D visual images is enhanced by accounting for the content of the visual images. For example, the visual image content includes an emotional rating so that the end user’s emotional response to the content is considered when determining the end user’s emotional state due to strain from viewing the 3D images or enjoyment from viewing 3D images. Alternatively, the machine learning model can evaluate the content as it is presented to the end user to determine an emotional rating of the content. Once the content emotional rating is determined, an adjustment to the facial readings of the camera vision may be applied. For instance, during sad scenes a SAD end user evaluation will be offset for the emotional content of the movie. During exciting scenes a steady stare end user evaluation will be offset for the greater attention called for by the content. In one example embodiment, the camera vision is viewed over time to identify emotionally neutral content for the evaluation of the end user’s emotional state to determine the impact of the 3D visual images on the end user.

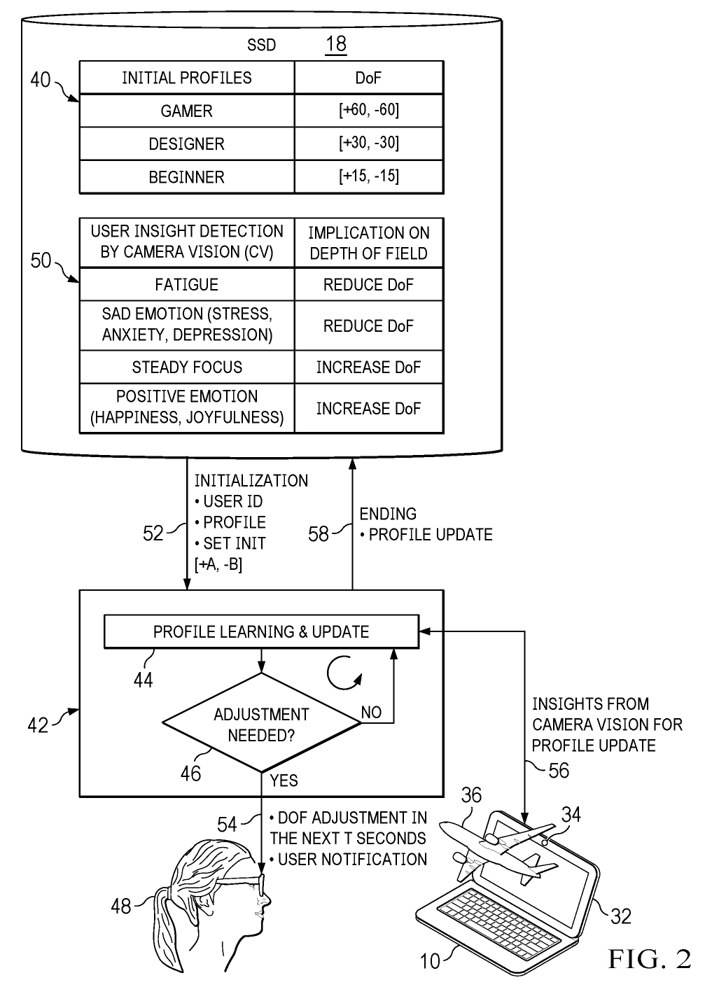

Referring now to FIG. 2, a flow diagram depicts a process for adapting an autostereoscopic three dimensional display to present visual images with an adjustable depth of field based on an end user reaction to three dimensional visual images as captured by a camera. The process starts at information handling system 10 presenting a 3D visual image 36 to an end user 48, such as a CAD model of an airplane. The initiation of three dimensional image presentation is detected by a depth of field engine 42, which retrieves from SSD 18 initialization information for the presentation of the 3D visual images to the end user. When no profile exists for the end user, the depth of field table 40 is used for initialization, such as with an end user self-selection of familiarity with viewing 3D visual images. When an end user profile 52 exists, such as by association with the end users ID, the profile for the end user is provided to the depth of field engine 42 to initialize a depth of field for presentation of the 3D visual images. Within depth of field engine 42 a profile learning and update logic 44 receives the end user profile, the camera vision and any adjustments performed to the depth of field and stores updates at step 58 to the end user profile in SSD 18. At step 46 a determination is made of whether an adjustment is needed to the depth of field. As described above and shown in table 50, the analysis of camera vision 56 determines that an update is needed to reduce depth of field when an end user exhibits stress and to increase depth of field when an end user exhibits enjoyment. The depth of field adjustment 54 is applied at information handling system 10 and the process continues to monitor the camera vision for further adjustments. In one embodiment, the depth of field is set to enable an end user to view the 3D visual images for a predetermined time, such as to the end of a movie or for a defined work period.

Although the present invention has been described in detail, it should be understood that various changes, substitutions and alterations can be made hereto without departing from the spirit and scope of the invention as defined by the appended claims.

What is claimed is:

1. An information handling system comprising:
a processor operable to execute instructions to process information;
a memory interfaced with the processor and operable to store the instructions and information;
a display interfaced with the processor and operable to present the information as visual images, the display having autostereoscopic 3D visual image presentation with a selectable depth of field;
a camera aligned to capture visual images of a viewing position of the display to capture in the visual images an end user viewing the display; and
a non-transitory memory interfaced with the processor and storing instructions that when executed cause:
identification in the visual image of the end user one or more predetermined conditions associated with the end user; and
in response to the one or more predetermined conditions, adjustment of the depth of the field of the visual images.

2. The information handling system of claim 1 further comprising:
visual image content stored in the non-transitory memory and having depth of field information including a maximum desired depth of field; and
an instruction stored in the non-transitory memory that when executed scales the adjustment of the depth of field of the visual images as a function of maximum desired depth of field and a user profile depth of field.

3. The information handling system of claim 2 wherein the depth of field includes a front depth of field and a rear depth of field scaled independently of each other.

4. The information handling system of claim 2 wherein the predetermined condition comprises fatigue of the end user and the adjustment comprises decreasing the depth of field.

5. The information handling system of claim 2 wherein the predetermined condition comprises sadness of the end user and the adjustment comprises decreasing the depth of field.

6. The information handling system of claim 2 wherein the predetermined condition comprises steady focus of the end user and the adjustment comprises increasing the depth of field.

7. The information handling system of claim 2 wherein the predetermined condition comprises happiness of the end user and the adjustment comprises increasing the depth of field.

8. The information handling system of claim 2 further comprising:
visual image content stored in the non-transitory memory and having an emotional rating of the content; and
an instruction stored in the non-transitory memory that when executed compares an emotional state of the end user captured in the visual image with an emotional rating of the content to find the one or more predetermined conditions.

9. The information handling system of claim 2 further comprising instructions stored in the non-transitory memory that when executed cause:
capture of plural visual images over a predetermined time;
comparing the plural visual images to determine an emotional state of the end user neutral of visual image content; and
applying the emotional state of the end user neutral of content to find the one or more predetermined conditions.

10. A method for adjusting the depth of field of a visual image presented at an autostereoscopic 3D display, the method comprising:
capturing a visual image of an end user viewing the visual image presented at the autostereoscopic 3D display;
identifying in the visual image of the end user one or more predetermined conditions associated with the end user; and
in response to the one or more predetermined conditions, adjusting the depth of the field of the visual images.

11. The method of claim 10 further comprising:
presenting the visual image from content having depth of field information including a maximum desired depth of field; and
scaling the adjusting of the depth of field of the visual images as a function of maximum desired depth of field and a user profile depth of field.

12. The method of claim 11 wherein the depth of field includes a front depth of field and a rear depth of field scaled independently of each other.

13. The method of claim 11 wherein the predetermined condition comprises fatigue of the end user and the adjusting comprises decreasing the depth of field.

14. The method of claim 11 wherein the predetermined condition comprises sadness of the end user and the adjustment comprises decreasing the depth of field.

15. The method of claim 11 wherein the predetermined condition comprises steady focus of the end user and the adjustment comprises increasing the depth of field.

16. The method of claim 11 wherein the predetermined condition comprises happiness of the end user and the adjustment comprises increasing the depth of field.

17. The method of claim 11 further comprising:
detecting an emotional state of the content; and
comparing an emotional state of the end user captured in the visual image with an emotional state of the content to find the one or more predetermined conditions.

18. The method of claim 11 further comprising:
capturing plural visual images of the end user over a predetermined time;
comparing the plural visual images to determine an emotional state of the end user neutral of visual image content presented at the autostereoscopic 3D display; and
applying the emotional state of the end user neutral of content presented at the autostereoscopic 3D display to find the one or more predetermined conditions.

19. A system for presenting visual images at three dimensional display comprising:
a camera aligned to capture visual images of a viewing position of the three dimensional display to capture in the visual images an end user viewing the display; and
a non-transitory memory storing instructions that when executed on a processor cause:
identification in the visual image of the end user one or more predetermined conditions associated with the end user;
determination of a maximum desired depth of field for content presented at the display; and
in response to the one or more predetermined conditions, adjusting of the depth of the field of the visual images by scaling the depth of field of the visual images as a function of maximum desired depth of field and a user profile depth of field.

20. The system of claim 19 further comprising instructions stored in the non-transitory memory that when executed cause:
capture of plural visual images with the camera over a predetermined time;
analyzing content presented at the 3D display for an emotional state of the visual images presented at the 3D display;
comparing the plural visual images of the end user and the content emotional state to determine an emotional state of the end user neutral of visual image content; and
applying the emotional state of the end user neutral of content to find the one or more predetermined conditions.
